(19) United States
(12) Patent Application Publication
(10) Pub. No.: US 2007/0177753 A1
(43) Pub. Date: Aug. 2, 2007

(54) EARPHONE WITH LEAKAGE CONTROL AND DEVICE THEREFOR

(75) Inventors: Erwin Weinans, Klijndik (NL); Rene Hin, Emmen (NL); Johan Schreuder, Borger (NL); Gerjo Sampimon, Emmen (NL)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SONY ERICSSON MOBILE COMMUNICATIONS AB, Lund (SE)

(21) Appl. No.: 11/307,255

(22) Filed: Jan. 30, 2006

(51) Int. Cl. H04R 25/00

(52) U.S. Cl. 381/373; 381/372

(57) ABSTRACT

The invention relates to an earphone (1) with leakage control, which can be switched between states with and without leakage to adapt the earphone to different listening situations. The leakage of the earphone may be enabled and disabled automatically in dependence of the sound source and/or may be controlled manually by the user. The earphone is connectable to a device and comprises: a housing (2) substantially covering the external auditory meatus, and accommodating a loudspeaker element (3); the housing further comprising a channel (4) extending between an inner end (5) facing the external auditory meatus, and an outer end (6) facing the environment; and closure means (7) being switchable between a closed state in which said channel is substantially closed, and an open state in which said channel is admitting sound from the environment. The invention also relates to a device co-operating therewith, such as a mobile telephone.

### FIELD OF THE INVENTION

The present invention relates to an earphone with leakage control, which can be switched between states with and without leakage to adapt the earphone to different listening situations. The invention also relates to a device co-operating therewith, such as a mobile telephone.

### STATE OF THE ART

Earphones are commonly used today e.g. together with mobile telephones and audio players. One type of earphone, that is often referred to as an earbud, is a small speaker-like device that is designed to fit within the outer ear of a user so that he can listen to sound being transmitted from a sound source. When properly positioned in the ear, the earphone can provide the listener with sound transmission directly to the ear canal, the external auditory meatus. The earphone enables the user to listen more closely and avoids holding the device to the ear in case of a telephone.

The earphone blocks out external sounds and surrounding noise to a varying extent. In some situation blocking is desired, typically listening to music or because the surrounding noise is disturbing the listener. In other situations there needs to be some leakage of surrounding noise, typically to enable a good voice audio quality when speaking on a phone, and when the user wants to hear the surrounding noise, e.g. in a traffic situation.

Today's earphones are static, i.e. either the earphone permits some leakage or not.

### SUMMARY OF THE INVENTION

An object of the present invention is to provide an earphone with controllable leakage. The leakage of the earphone may be enabled and disabled automatically in dependence of the sound source and/or may be controlled manually by the user.

In a first aspect, the invention provides an earphone connectable to a device and comprising:
a housing being shaped and configured to substantially cover the external auditory meatus when the earphone is worn, and accommodating a loudspeaker element directed to emit sound into the external auditory meatus; the housing further comprising a channel extending between an inner end disposed to face the external auditory meatus when the earphone is worn, and an outer end disposed to face the environment when the earphone is worn; and closure means being switchable between a closed state in which said channel is substantially closed, and an open state in which said channel is open to admit sound from the environment.

In one embodiment, the closure means is connected to an actuator for switching the closure means between its states in dependence of control signals received from the device.

In a further embodiment, the closure means comprises a slidable cover at the outer end of the channel.

The cover may comprise an actuating part to be engaged manually for switching the cover between its states.

Suitably, the cover is connected to an actuator for switching the cover between its states in dependence of control signals received from the device.

In a further embodiment, the closure means comprises a controllable membrane.

Suitably, the membrane is connected to an actuator for switching the membrane between its states in dependence of control signals received from the device.

The actuator may be arranged to control a bias voltage applied on the membrane.

In a second aspect, the invention provides a device comprising:

a user interface for entering commands from a user;

an audio player;

a telephone phone part; and

a control unit;

the device being adapted to cooperate with an earphone having a closed state and an open state in which states the earphone is closed and opened, respectively, to sound from the environment, the earphone being switchable by means of an actuator for switching between the open and closed states, wherein the control unit is adapted to control the actuator.

In one embodiment, the control unit is adapted to control the actuator automatically in dependence of an operation mode of the device.

The control unit may be adapted to switch the earphone automatically to an open state when the device is in a telephone operation mode, and adapted to switch the earphone to a closed state when the device is in an audio player operation mode.

Also, the control unit may be adapted to switch the earphone in dependence of commands from a user entered through the user interface.

Suitably, the control unit is adapted to switch the earphone in dependence of commands from a user entered through the user interface, said commands overriding the automatic switching.

The device may be a portable telephone, a communicator, or a smart phone.

### BRIEF DESCRIPTION OF THE DRAWINGS

The invention will be described in detail below with reference to the attached drawings, in which:

FIG. 1 is a side view of an earphone according to the invention,

FIGS. 2A and 2B are schematic views of an earphone according to the invention in an open and closed state, respectively, and

FIG. 3 is a schematic view of a device connectable to an earphone according to the invention.

### DETAILED DESCRIPTION OF PREFERRED EMBODIMENTS

The invention will be described in the context of mobile telephones and similar devices, such as communicators and smart phones. As is known, a mobile telephone may be used with an earphone to improve the hearing and freeing the hands for driving etc. Also, modern telephones often incorporate players for audio and video. Then stereo earphones are normally used, i.e. one earphone each for the left and the right ear.

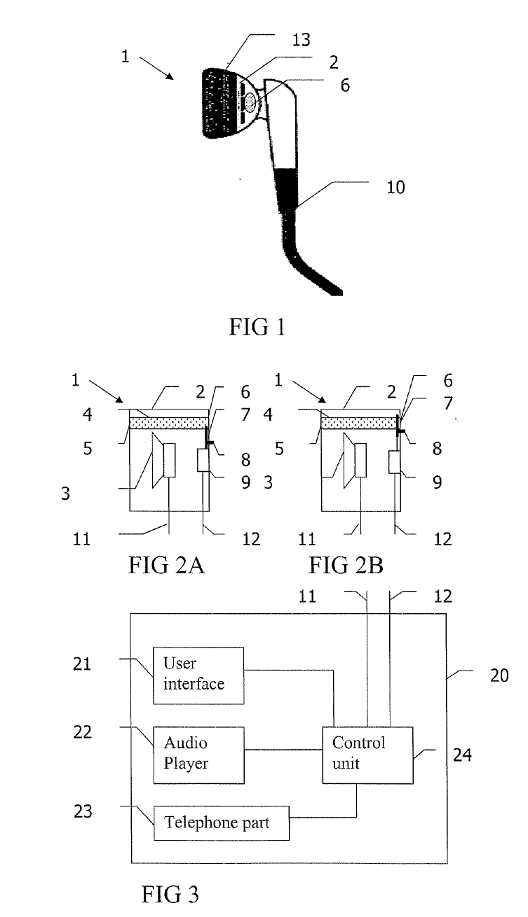

A typical earphone model is shown in FIG. 1. The earphone 1 has a part fitting as a plug in the outer ear of a listener. For comfort, the earphone has a padding 13 so that the earphone may rest in the outer ear in close contact with the ear canal, the external auditory meatus. In this position the earphone 1 more or less seals off the ear canal. The earphone is connected by means of a cord 10 to a sound source, such as the device described below with reference to FIG. 3. The connection to the device may also be by means of short range radio communication (Bluetooth®) etc.

For best audio quality when listening to music and other audio sources no leakage of surrounding sound is desired. On the other hand, when using the connected device as a telephone and in other situations, leakage may be preferred.

FIGS. 2A and 2B illustrate schematically an embodiment of an earphone according to the invention. The earphone 1 comprises a housing 2 to accommodating the loudspeaker element 3. The housing has openings (not shown) letting sound pass from the loudspeaker element 3 into the ear of the user.

The housing has a channel 4, which is open at one end 5 towards the ear and has an opening with closure means at the other end 6 toward the surrounding atmosphere. The channel may be shaped in various ways. Generally, it is a space within the housing 2 communicating sounds from a position directed towards the surrounding air and another position directed towards the ear.

A closure means is arranged at the outer end 6 of the channel 4. As is shown, the closure means may be a slidable cover 7. In FIG. 2A the cover 7 is open. In FIG. 2B the cover 7 is closed. The cover may be provided with a pin 8 or other actuating part which the user may move manually with his fingernail.

In another embodiment the cover 7 is connected to an actuator 9, which is capable of switching the cover between open and closed positions. The actuator may be an electric motor or relay, receiving control signals from the connected device through a control signal line 12.

The loudspeaker 3 is connected through audio signal lines 11 to the sound source. Suitably, the audio signal lines and the control signal line are collected in the cord 10.

In a further embodiment the closure means is a membrane covering the channel at the outer end. The membrane is connected to an actuator, which may switch the membrane between two states in which it has different acoustical characteristics. For example, the membrane may be biased to a higher tension in which it is not letting any sound pass in one state, and relaxed in another state letting sound pass like an open channel. The membrane can be controlled with a bias voltage passing trough a coil. This bias voltage could be the same voltage which is used for a microphone as in a portable handsfree construction. When the phone is in telephone mode it activates its bias voltage automatically as is conventional in a telephone. This will give the user the possible to switch from close to open mode when there is an active call.

FIG. 3 illustrates schematically a device suitable for use with an earphone according to the invention. In one embodiment the device comprises a user interface 21, such as a keypad with a joystick and/or voice control, an audio player 22 for playing MP3 files or other audio and video files, a telephone part 23 handling the radio interface etc of the telephone functions and a control unit 24 receiving commands from the user interface 21 and performing processing and switching of signals relating to various operations of the device.

Some typical operational cases are explained below. When listening to music, the user would normally prefer not to hear any noise from the surroundings. Thus, the channel 4 should be closed. First the user operates a device 20 to select an audio player mode and a desired music track. The control unit 24 then senses the operation mode and automatically switches the closure means 7 to the closed state by issuing suitable control signals to the actuator 9. In another embodiment, the user has to close the closure means himself manually.

In a telephone mode, the audio quality on the other hand is best with leakage. When the user places or receives a call, the control unit 24 senses the operation mode and automatically switches the closure means 7 to the open state by sending suitable control signals to the actuator, and activates the bias voltage of the membrane automatically as the case may be. In another embodiment, the user has to open the closure means himself manually.

On the other hand, in some situations the user may want to override the automatic control or preset the device 20 in accordance with his own preferences. For example, the user may want to listen to music with the earphone in the open state in order to be able to hear what is going on in the surroundings. Also, the user may want to talk on the phone with the earphone in a closed state when he is having a conversation in a noisy environment. Then, the user may preset the device 20 to always keep the channel open or closed in all situations, or may present the device to switch the earphone to closed state when speaking on the phone and to the open state when listening to music, or vice versa.

The inventions may be implemented by suitable combinations of software and hardware as is known in the art. Changes may be made in details, particularly in matters of shape, size and arrangement without exceeding the scope of the invention. The scope of the invention is only limited by the attached claims.

What is claimed is:

1. An earphone connectable to a device and comprising:
a housing being shaped and configured to substantially cover the external auditory meatus when the earphone is worn, and accommodating a loudspeaker element directed to emit sound into the external auditory meatus;
the housing further comprising a channel extending between an inner end disposed to face the external auditory meatus when the earphone is worn, and an outer end disposed to face the environment when the earphone is worn; and
closure means being switchable between a closed state in which said channel is substantially closed, and an open state in which said channel is open to admit sound from the environment.

2. An earphone according to claim 1, wherein the closure means is connected to an actuator for switching the closure means between its states in dependence of control signals received from the device.

3. An earphone according to claim 1, wherein the closure means comprises a slidable cover at the outer end of the channel.

4. An earphone according to claim 3, wherein the cover comprises an actuating part to be engaged manually for switching the cover between its states.

5. An earphone according to claim 3, wherein the cover is connected to an actuator for switching the cover between its states in dependence of control signals received from the device.

6. An earphone according to claim 1, wherein the closure means comprises a controllable membrane.

7. An earphone according to claim 6, wherein the membrane is connected to an actuator for switching the membrane between its states in dependence of control signals received from the device.

8. An earphone according to claim 7, wherein the actuator is arranged to control a bias voltage applied on the membrane.

9. A device comprising:
a user interface for entering commands from a user;
an audio player;
a telephone phone part; and
a control unit;
the device being adapted to cooperate with an earphone having a closed state and an open state in which states the earphone is closed and opened, respectively, to sound from the environment, the earphone being switchable by means of an actuator for switching between the open and closed states, wherein the control unit is adapted to control the actuator.

10. A device according to claim 9, wherein the control unit is adapted to control the actuator automatically in dependence of an operation mode of the device.

11. A device according to claim 10, wherein the control unit is adapted to switch the earphone automatically to an open state when the device is in a telephone operation mode, and adapted to switch the earphone to a closed state when the device is in an audio player operation mode.

12. A device according to claim 9, wherein the control unit is adapted to switch the earphone in dependence of commands from a user entered through the user interface.

13. A device according to claim 10, wherein the control unit is adapted to switch the earphone in dependence of commands from a user entered through the user interface, said commands overriding the automatic switching.

14. A device according to claim 9, wherein the device is a portable telephone, a communicator, or a smart phone.
